(19) United States
(12) Patent Application Publication
(10) Pub. No.: US 2021/0229123 A1
(43) Pub. Date: Jul. 29, 2021

(54) ENVIRONMENT-FRIENDLY LOTION PUMP STRUCTURE

(71) Applicant: MAJESTY PACKAGING SYSTEMS LIMITED, Zhongshan City, Guangdong Province (CN)

(72) Inventors: Peihui LIANG, Zhongshan City (CN); Maoyong ZHU, Zhongshan City (CN); Yonglei ZHANG, Zhongshan City (CN); Jinkao LIANG, Zhongshan City (CN)

(73) Assignee: Majesty Packaging Systems Limited, Zhongshan City, Guangdong Province (CN)

(21) Appl. No.: 16/770,249

(22) PCT Filed: Jan. 17, 2020
(86) PCT No.: PCT/CN2020/072679

§ 371 Date: Jun. 5, 2020

(30) Foreign Application Priority Data
Apr. 12, 2019 (CN) 201910294315.4

(51) Int. Cl. B05B 11/00; A47K 5/12

(52) U.S. Cl. CPC B05B 11/3047; B05B 11/0089; A47K 5/1205; B05B 11/3059; B05B 11/3074; B05B 11/3023

(57) ABSTRACT

A lotion pump structure includes a pump body extending into a bottle body and has a pump chamber and connected with a bottle-locking cap for fixing the pump body to the bottle body, the pump chamber internally has a pumping assembly to pump lotion upwards; the pump chamber lower end has a one-way valve, the pumping assembly upper end is connected with a bent mouth, the pump chamber inner wall has a locking cap, and a spring is between the locking cap upper end surface and the bent mouth; the pumping assembly includes a pump lever having at least one liquid inlet and connected with a piston, a limit assembly is between the pump lever and the locking cap to prevent the bent mouth from being pressed down when the pump lever rotates a certain angle. The structure is simple, self-locking, plastic, convenient for recycling, energy-saving and environmentally friendly.

### TECHNICAL FIELD

The invention relates to environment-friendly lotion pump structure.

### BACKGROUND ART

Lotion pumps have been widely used in daily chemicals, medicine and other industries because of exquisite designs and convenience. However, the existing lotion pump has many parts, complex structure, difficult manufacturing and high production cost; and the return spring of the pumping assembly of the conventional lotion pump can directly contact lotion in the pump chamber, which leads to pollution and insalubrity if the return spring rusts. Moreover, during the use of the existing lotion pump, the bent mouth can be easily pressed by mistake, causing waste or inconvenience to the user.

Therefore, the invention is provided to address the above defects.

### SUMMARY OF THE INVENTION

The technical problem to be solved by the invention is to provide an environment-friendly lotion pump structure with simple structure and stable performance.

In order to solve the above technical problems, the invention adopts the following technical solutions:

An environment-friendly lotion pump structure, comprises a pump body 1 extending into a bottle body, the pump body 1 is provided with a pump chamber 2, the pump body 1 is connected with a bottle-locking cap 3 used for fixing the pump body 1 to the bottle body, and the pump chamber 2 is internally provided with a pumping assembly 4 capable of moving up and down in the pump chamber 2 to pump lotion in the bottle body upwards; the pump chamber 2 is provided, at the lower end thereof, with a one-way valve 5 only for discharging the lotion in the bottle body upwards during the movement of the pumping assembly 4, the upper end of the pumping assembly 4 is connected with a bent mouth 6, the inner wall of the pump chamber 2 is provided with a locking cap 7 which can prevent the pumping assembly 4 from coining out of the pump chamber 2, and a spring 8 is provided between the upper end surface of the locking cap 7 and the bent mouth 6; the pumping assembly 4 comprises a pump lever 41 passing through the locking cap 7 and having a pumping channel 411, the pump lever 41 is provided with at least one liquid inlet 412 connecting with the pumping channel 411, and the pump lever 41 is connected with a piston 42 which can move up and down relative to the pump lever 41 and can seal the liquid inlet 412, a limit assembly 9 is provided between the pump lever 41 and the locking cap 7 to prevent the bent mouth 6 from being pressed down when the pump lever 41 rotates by a certain angle.

In the environment-friendly lotion pump structure, the outer wall of the pump lever 41 is provided with an upper limit convex ring 413 which is located above the liquid inlet 412, and the outer wall of the pump lever 41 is further provided with a lower limit convex ring 414 which is located below the liquid inlet 412, the piston 42 is located between the upper limit convex ring 413 and the lower limit convex ring 414.

In the environment-friendly lotion pump structure, the limit assembly 9 comprises at least one convex rib 91 vertically arranged on the outer side wall of the pump lever 41, and the inner wall of the locking cap 7 is provided with at least one guide groove 71 for the corresponding convex rib 91 to slide up and down inside, the inner wall of the guide groove 71 is provided with a boss 92 for abutting the convex rib 91 and preventing the convex rib 91 from sliding up and down after the pump lever 41 rotates at a certain angle.

In the environment-friendly lotion pump structure, the outer side of the locking cap 7 is provided with at least one clamping part 72, the pump chamber 2 is provided with at least one positioning connection part 21 into which the clamping part 72 is engaged correspondingly, the clamping part 72 comprises a first concave part 721 and a first convex part 722, and the positioning connection part 21 comprises a second convex part 211 matched with the first concave part 721 and a second concave part 212 matched with the first convex part 722.

In the environment-friendly lotion pump structure, the bent mouth 6 is provided with a connecting part 61 capable of connecting with the upper end of the pump lever 41, and the bent mouth 6 is provided with a clamping groove 62 for the upper end of the spring 8 to be clamped in, and the clamping groove 62 is located outside the connecting part 61.

In the environment-friendly lotion pump structure, two convex ribs 91 are vertically arranged on the outer side wall of the pump lever 41, and the inner wall of the locking cap 7 is provided with two guide grooves 71 matched with the convex ribs 91 respectively.

In the environment-friendly lotion pump structure, the bottle-locking cap 3 is further internally provided with at lest one gasket 10, and the gasket 10 is in a ring shape.

In the environment-friendly lotion pump structure, the lower end of the pump chamber 2 is conical, and the one-way valve 5 is a pump bead provided at the lower end of the pump chamber 2.

In the environment-friendly lotion pump structure, the pump body 1 is further provided with a diptube 11 which is located below the one-way valve 5.

In the environment-friendly lotion pump structure, the lotion pump is made of plastic.

Compared with the prior art, the invention provides an environment-friendly lotion pump structure, which achieves the following advantages:

1. According to the invention, the spring is disposed between the upper end surface of the locking cap and the bent mouth and above the piston, so that the spring cannot contact the lotion when the pumping assembly moves up and down to pump the lotion into space of the pump chamber below the piston. Therefore, according to the structure of the invention, the spring and the lotion are completely separated, hygiene is guaranteed, and pollution to the lotion is avoided.

2. The limit assembly is provided between the pump lever and the locking cap to prevent the bent mouth from being pressed down when the pump lever rotates by a certain angle. Self-locking is achieved through the cooperation of the guide rail of the pump lever and the guide groove of the locking cap, the bent mouth cannot be pressed down to prevent the liquid from being squeezed and leaked when the lotion pump is not used.

3. All the components of the invention are made of plastic, which can avoid liquid corrosion and prolong service life. These plastic components are light and simple in structure, convenient for recycling, energy-saving and environmentally friendly.

4. The locking cap and the pump chamber are clamped through multiple convex parts and concave parts to ensure firm connection and prevent the locking cap from coining out of the pump chamber.

### BRIEF DESCRIPTION OF THE DRAWINGS

The specific embodiments of the present invention will be further described in detail below with reference to the drawings, wherein:

FIG. 1 is a perspective view of the invention;

FIG. 2 is an exploded view of the invention;

FIG. 3 is a sectional view of the invention when the bent mouth is not being pressed down;

FIG. 4 is an enlarged view of part A of FIG. 3;

FIG. 5 is a perspective view of the locking cap of the invention.

Label: 1. pump body; 2. pump chamber; 21. positioning connection part; 211. second convex part; 212. second concave part; 3. bottle-locking cap; 4. pumping assembly; 41. pump lever; 411. pumping channel; 412. liquid inlet; 413. upper limit convex ring; 414. lower limit convex ring; 42. piston; 5. one-way valve; 6. bent mouth; 61. connecting part; 62. clamping groove; 7. locking cap; 71. guide groove; 72. clamping part; 721. first concave part; 722. first convex part; 8. spring; 9. limit assembly; 91. convex rib; 92. boss; 10. gasket; 11. diptube.

### DETAILED DESCRIPTION OF THE INVENTION

The technical solutions in the embodiments of the invention will be described clearly and completely in combination with the drawings of the invention.

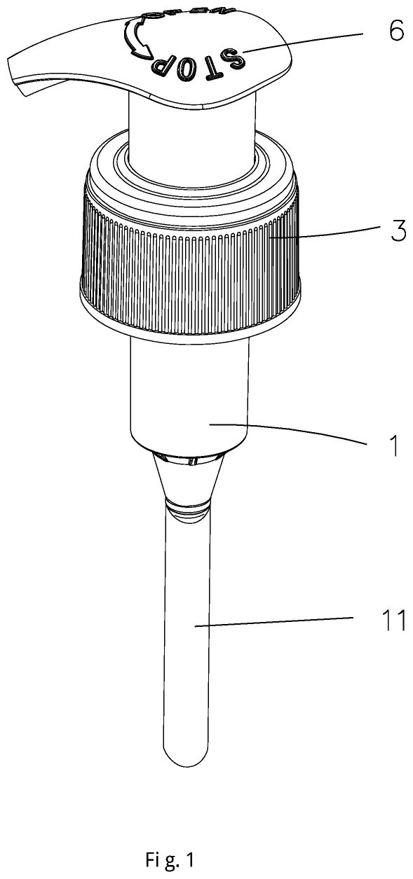

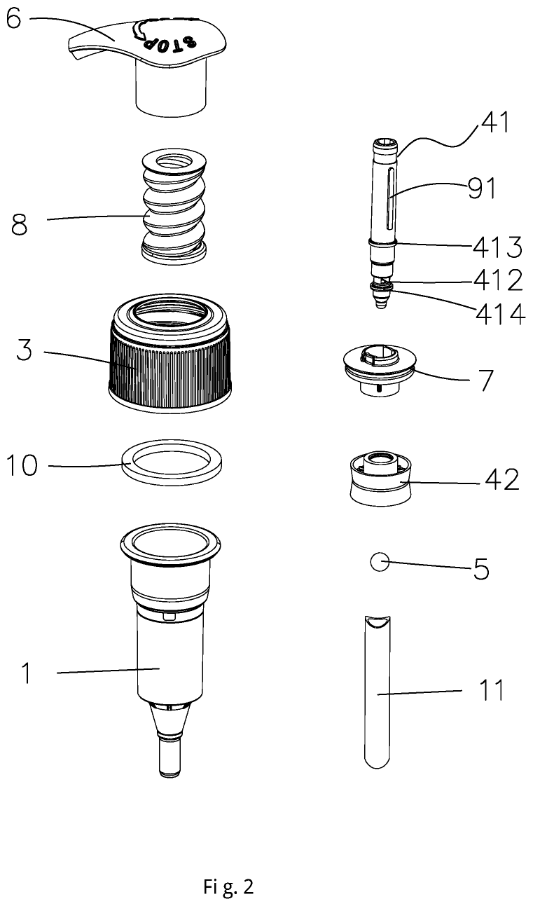

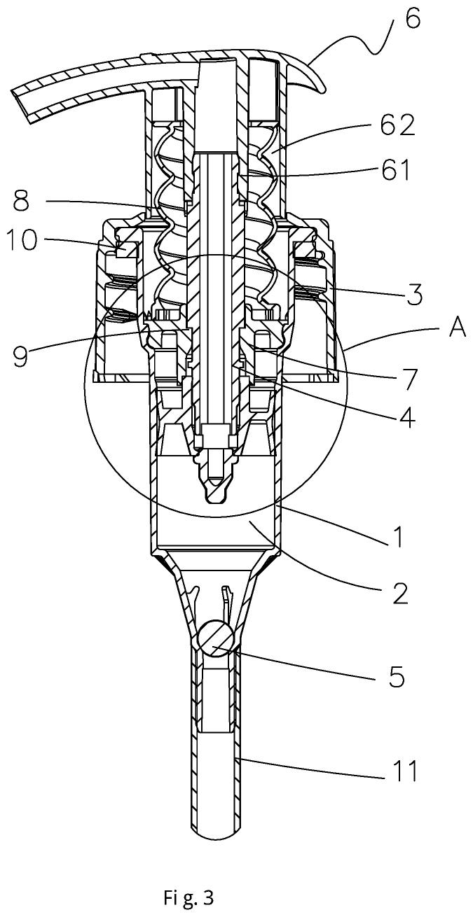

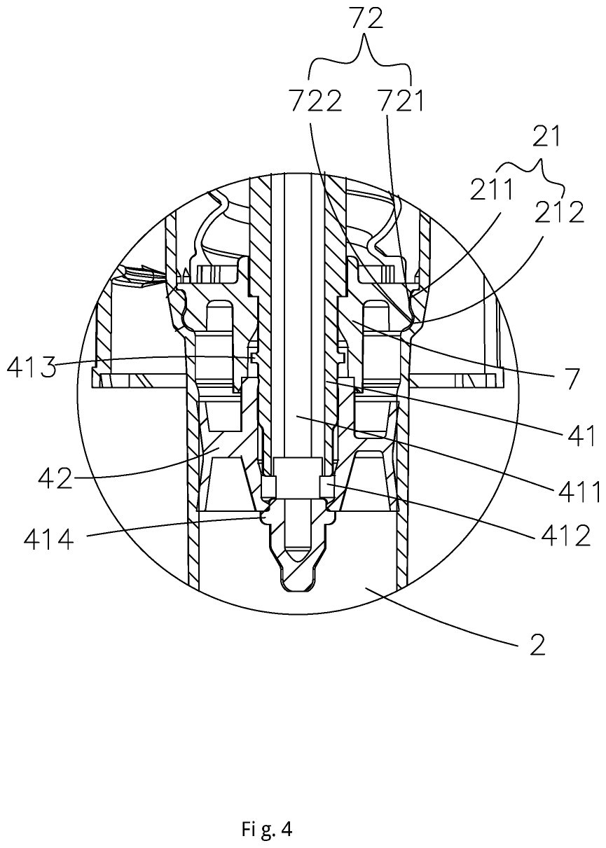

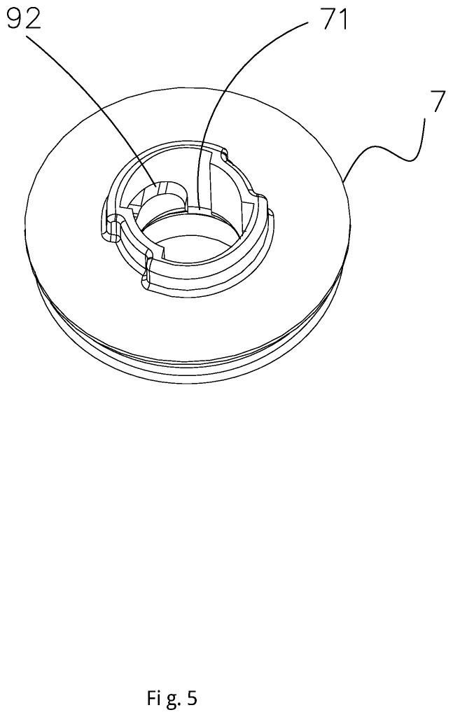

As shown in FIG. 1 to FIG. 5, an environment-friendly lotion pump structure, comprises a pump body 1 extending into a bottle body, the pump body 1 is provided with a pump chamber 2, the pump body 1 is connected with a bottle-locking cap 3 used for fixing the pump body 1 to the bottle body, and the pump chamber 2 is internally provided with a pumping assembly 4 capable of moving up and down in the pump chamber 2 to pump lotion in the bottle body upwards; the pump chamber 2 is provided, at the lower end thereof, with a one-way valve 5 only for discharging the lotion in the bottle body upwards during the movements of the pumping assembly 4, the upper end of the pumping assembly 4 is connected with a bent mouth 6, the inner wall of the pump chamber 2 is provided with a locking cap 7 which can prevent the pumping assembly 4 from coining out of the pump chamber 2, and a spring 8 is provided between the upper end surface of the locking cap 7 and the bent mouth 6; the pumping assembly 4 comprises a pump lever 41 passing through the locking cap 7 and having a pumping channel 411, the pump lever is integrally formed with a simple structure, the pump lever 41 is provided with at least one liquid inlet 412 connecting with the pumping channel 411, and the pump lever 41 is connected with a piston 42 capable of moving up and down relative to the pump lever 41 and sealing the liquid inlet 412, a limit assembly 9 is provided between the pump lever 41 and the locking cap 7 to prevent the bent mouth 6 from being pressed down when the pump lever 41 rotates by a certain angle. Setting a limit assembly between the pump lever and the locking cap can protect the limit assembly. According to the invention, the spring is disposed between the upper end surface of the locking cap and the bent mouth and above the piston, so that the spring cannot contact the lotion when the pumping assembly moves up and down to pump the lotion into space of the pump chamber below the piston. Therefore, the spring and the lotion are completely separated, hygiene is guaranteed, and pollution to the lotion is avoided. The limit assembly is provided between the pump lever and the locking cap to prevent the bent mouth from being pressed down when the pump lever rotates by a certain angle. Self-locking is achieved through the cooperation of the guide rail of the pump lever and the matching groove of the locking cap, then the bent mouth cannot be pressed down.

As shown in FIG. 1 to FIG. 5, in the embodiments, the outer wall of the pump lever 41 is provided with an upper limit convex ring 413 which is located above the liquid inlet 412, and the outer wall of the pump lever 41 is further provided with a lower limit convex ring 414 which is located below the liquid inlet 412, the piston 42 is located between the upper limit convex ring 413 and the lower limit convex ring 414.

As shown in FIG. 1 to FIG. 5, in the embodiments, the limit assembly 9 comprises at least one convex rib 91 vertically arranged on the outer side wall of the pump lever 41, and the inner wall of the locking cap 7 is provided with at least one guide groove 71 for the convex rib 91 to slide up and down inside correspondingly, the inner wall of each guide groove 71 is provided with a boss 92 for abutting the convex rib 91 correspondingly and preventing the convex rib 91 from sliding up and down after the pump lever 41 rotates at a certain angle.

As shown in FIG. 1 to FIG. 5, in the embodiments, the outer side of the locking cap 7 is provided with at least one clamping part 72, the pump chamber 2 is provided with at least one positioning connection part 21 into which the clamping part 72 is engaged correspondingly, the clamping part 72 comprises a first concave part 721 and a first convex part 722, and the positioning connection part 21 comprises a second convex part 211 matched with the first concave part 721 and a second concave part 212 matched with the first convex part 722. Through the double cooperation of the first concave part and the second convex part, the first convex part and the second concave part, the locking cap is further fixed inside the pump chamber, preventing the locking cap from coining out of the pump chamber, and increasing the structural stability. The first convex part 722 has a certain elasticity, first passes through the second convex part, and then is clamped into the second concave part to form a clamping joint, the upper end of the first concave part 721 abuts against the upper end of the second convex part 211 to prevent further downward movement of the locking cap 7.

As shown in FIG. 1 to FIG. 5, in the embodiments, the bent mouth 6 is provided with a connecting part 61 which can be connected with the upper end of the pump lever 41, and the bent mouth 6 is provided with a clamping groove 62 for the upper end of a spring 8 to be clamped in, and the clamping groove 62, which is used to locate the spring and prevent its deformation, is located outside the connecting part 61.

As shown in FIG. 1 to FIG. 5, in the embodiments, two convex ribs 91 are vertically arranged on the outer side wall of the pump lever 41, and the inner wall of the locking cap 7 is provided with two guide grooves 71 matched with the convex ribs 91 respectively.

As shown in FIG. 1 to FIG. 5, in the embodiments, the bottle-locking cap 3 is further internally provided with at least one gasket 10, and the gasket 10 has a ring structure, which plays the role of sealing the bottle body.

As shown in FIG. 1 to FIG. 5, in the embodiments, the lower end of the pump chamber 2 is conical, and the one-way valve 5 is a pump bead provided at the lower end of the pump chamber 2.

As shown in FIG. 1 to FIG. 5, in the embodiments, the pump body 1 is further provided with a diptube 11 which is located below the one-way valve 5.

As shown in FIG. 1 to FIG. 5, in the embodiments, the lotion pump is made of plastic, and all the components of the invention are made of plastic, which can avoid liquid corrosion. These plastic materials are light in structure, convenient for recycling, energy-saving and environmentally friendly.

### Working Principle

1.Pressing the bent mouth to overcome the spring force and drive the pump lever downward, the piston lags due to friction with the pump chamber. At this time, the channel between the pump lever and the piston is opened. The pump lever continues to be driven down, the upper limit convex ring presses the piston and moves down together, which can discharge the partial gas in the pump chamber from the pumping channel

2. When the bent mouth is released, and reset under the spring force, the piston lags, and the channel between the piston and the pump lever is instantly sealed. At this time, a partial vacuum is formed in the pump chamber, under the action of atmospheric pressure, the solution can be led into the diptube, thrusting the pump bead away, then entering into the pump chamber, the solution can be sprayed from the bent mouth when pressing continuously.

1. An environment-friendly lotion pump structure, comprising a pump body extending into a bottle body, the pump body is provided with a pump chamber, the pump body is connected with a bottle-locking cap used for fixing the pump body to the bottle body, and the pump chamber is internally provided with a pumping assembly capable of moving up and down in the pump chamber to pump lotion in the bottle body upwards; the pump chamber is provided, at the lower end thereof, with a one-way valve only for discharging the lotion in the bottle body upwards during the movements of the pumping assembly, the upper end of the pumping assembly is connected with a bent mouth, the inner wall of the pump chamber is provided with a locking cap which can prevent the pumping assembly from coming out of the pump chamber, and a spring is provided between the upper end surface of the locking cap and the bent mouth; the pumping assembly comprises a pump lever passing through the locking cap and having a pumping channel, the pump lever is provided with at least one liquid inlet connecting with the pumping channel, and the pump lever is connected with a piston which can move up and down relative to the pump lever and can seal the liquid inlet, a limit assembly is provided between the pump lever and the locking cap to prevent the bent mouth from being pressed down when the pump lever rotates by a certain angle.

2. The environment-friendly lotion pump structure according to claim 1, wherein the outer wall of the pump lever is provided with an upper limit convex ring which is located above the liquid inlet, and the outer wall of the pump lever is further provided with a lower limit convex ring which is located below the liquid inlet, the piston is located between the upper limit convex ring and the lower limit convex ring.

3. The environment-friendly lotion pump structure according to claim 1, the limit assembly comprises at least one convex rib vertically arranged on the outer side wall of the pump lever, and the inner wall of the locking cap is provided with at least one guide groove for the corresponding convex rib to slide up and down inside, the inner wall of the guide groove is provided with a boss for abutting the convex rib and preventing the convex rib from sliding up and down after the pump lever rotates at a certain angle.

4. The environment-friendly lotion pump structure according to claim 1, the outer side of the locking cap is provided with at least one clamping part, the pump chamber is provided with at least one positioning connection part into which the clamping part is engaged correspondingly, the clamping part comprises a first concave part and a first convex part, and the positioning connection part comprises a second convex part matched with the first concave part and a second concave part matched with the first convex (722)part.

5. The environment-friendly lotion pump structure according to claim 1, the bent mouth is provided with a connecting part capable of connecting with the upper end of the pump lever, and the bent mouth is provided with a clamping groove for the upper end of the spring to be clamped in, and the clamping groove is located outside the connecting part.

6. The environment-friendly lotion pump structure according to claim 3, two convex ribs are vertically arranged on the outer side wall of the pump lever, and the inner wall of the locking cap is provided with two guide grooves matched with the convex ribs respectively.

7. The environment-friendly lotion pump structure according to claim 1, the bottle-locking cap is further internally provided with at least one gasket, and the gasket is in a ring shape.

8. The environment-friendly lotion pump structure according to claim 1, the lower end of the pump chamber is conical, and the one-way valve is a pump bead provided at the lower end of the pump chamber.

9. The environment-friendly lotion pump structure according to claim 1, the pump body is further provided with a diptube which is located below the one-way valve.

10. The environment-friendly lotion pump structure according claim 1, wherein the lotion pump is made of plastic.
